(19) United States
(12) Patent Application Publication
(10) Pub. No.: US 2011/0210184 A1
(43) Pub. Date: Sep. 1, 2011

(54) Device for mixing media and method for producing same ("aeroflair spray nozzle")

(75) Inventors: Wilhelmus Johannes Joseph Maas, Someren (NL); Petrus Lambertus Wilhelmus Hurkmans, Someren (NL); Aaron S. Haleva, Oakhurst, NJ (US)

(73) Assignee: Dispensing Technologies B.V., DN Helmond (NL)

(21) Appl. No.: 12/928,958

(22) Filed: Dec. 23, 2010

Related U.S. Application Data
(60) Provisional application No. 61/456,648, filed on Nov. 10, 2010.

(30) Foreign Application Priority Data
Dec. 23, 2009 (NL) NL2004012

(51) Int. Cl. B05B 7/04

(52) U.S. Cl. 239/8; 239/398

(57) ABSTRACT

Various spray devices are presented for mixing two media. A device can include a housing, a first supply line for supplying a first medium, a second supply line for supplying a second medium, and a flow channel leading to a nozzle. The first and second media, for example, a gas and a liquid, respectively, can be mixed in various ways. Following such mixing, the mixed media are guided to an outlet nozzle or bore, and ejected. Using injection molding techniques, very fine grooves can be made in an exemplary spray nozzle device, by appropriately fashioning an injection mold. By carefully controlling the size, shape and dimensions of such grooves, and the pressures at which the two media are fed to the spray nozzle device, a correct ratio of air to liquid can be precisely maintained, which is key to obtaining a desired spray or foam as to droplet size, droplet speed, and type of spray, mist or foam.

### CROSS REFERENCE TO RELATED APPLICATIONS

This application claims priority to Netherlands Patent Application No. 2004012, filed on 23 Dec. 2009, entitled “Inrichting voor het vermengen van media, alsmede werkwijze voor de vervaardiging daarvan”, and U.S. Provisional Patent Application No. 61/456,648, entitled “Metered Dose Dispensing Flair,” filed on Nov. 10, 2010, each of which is hereby incorporated herein by this reference.

### TECHNICAL FIELD

The present invention relates to dispensing nozzles and other devices for mixing gaseous and liquid media, and to methods for manufacturing such devices.

### BACKGROUND OF THE INVENTION

Spray bottles for dispensing cleaning products, body care, insecticides and air fresheners are commercially available. Such spray bottles come in various versions, where air and liquid are mixed in order to obtain a spray, and the spray is then guided through a nozzle of the spray bottle and out to the environment. In certain applications, it is very desirable to have a small droplet size. Thus, there is a continuing need for the mingling of media in a mist-like spray pattern in order to obtain the smallest possible drop size. This is because for applications where a user desires to spray in a room, such as in the case of air freshener, or on a rather large surface, such as furniture polish on a large table, if the droplets are too large, say, for example 200 microns, the spray will simply fall on the floor a short distance in front of the spray nozzle. In order to travel forwards without immediately falling, the droplets in the spray need to have a small size and significant speed. Thus, it is often desired to control sprays so as to have droplet sizes in a range of, for example, 20-80 microns. It is often also the case that the distribution of droplet sizes is rather large, which reduces the consistency of the sprayed product both as to how it lands on a surface or space, and as to how effective it is-if only a subset of the droplet sizes sprayed are useful or effective, more and more product is needed to be used by a user each time it is sprayed.

What is needed in the art is an improved device to generate a mist-like spray pattern having a droplet size that is even smaller than what is conventionally available.

What are also needed in the art are improved methods and devices to precisely control the mix of liquid and gaseous media in spray bottles and the like so as to obtain a variety of desired gas/liquid ratios, nozzle speeds, droplet sizes, etc., as well as a small distribution of droplet sizes.

### BRIEF DESCRIPTION OF THE DRAWINGS

In what follows, the present invention is described via a number of examples, wherein reference is made to the accompanying drawings, in which:

FIG. 1 depicts an exemplary spray bottle containing an exemplary spray nozzle housing according to an exemplary embodiment of the present invention;

FIG. 2 depicts an exemplary spray nozzle according to an exemplary embodiment of the present invention;

FIG. 3 depicts a variant of the exemplary spray nozzle of FIG. 2;

FIG. 4 depicts an exemplary spray nozzle according to a third exemplary embodiment of the present invention, using a highly porous material to mix the gaseous and liquid media;

FIG. 5 depicts an exemplary spray nozzle according to a fourth exemplary embodiment of the present invention, using a helical groove surrounded by a porous material sleeve;

FIG. 6 depicts an exemplary spray nozzle according to fifth exemplary embodiment of the present invention, a variant of the spray nozzle of FIG. 4, using tapered grooves;

FIG. 7 depicts an exemplary spray nozzle according to a sixth exemplary embodiment of the present invention, a variant of the exemplary spray nozzle of FIG. 5, using a large flow path surrounded by a porous material sleeve, the flow path being narrowed at its distal end prior to feeding into a nozzle;

FIG. 8 depicts an exemplary spray nozzle according to a seventh exemplary embodiment of the present invention, which is a variant of the exemplary spray nozzle of FIG. 7;

FIG. 9 depicts an exemplary spray nozzle according to an eighth exemplary embodiment of the present invention, using a larger flow path at the end of which is a porous material;

FIG. 10 illustrates exemplary dispensing times for air, air/liquid mix and air (nozzle cleaning) according to exemplary embodiments of the present invention;

FIG. 11 depicts an exemplary metered dosed valve application using a spray nozzle according to an exemplary embodiment of the present invention;

FIGS. 12-13 depict details of the operation of the exemplary metered dosed valve application of FIG. 11;

FIG. 14 illustrates how the exemplary metered dosed valve of FIGS. 11-13 can also be operated manually, where a user's hand actuates the piston;

FIG. 15 depicts details of the automatic operation of a continuous (non-metered) valve according to an exemplary embodiment of the present invention;

FIG. 16 depicts details of a user (push-button) activated operation of a continuous (non-metered) valve according to an exemplary user activated embodiment of the present invention;

FIG. 17 depicts a perspective view and a cut-away perspective view of an exemplary dispensing device with an exemplary spray valve according to an exemplary embodiment of the present invention;

FIG. 18 depicts details of the liquid channel of the valve of FIG. 17;

FIG. 19 depicts details of the air channel of the valve of FIG. 17;

FIG. 20 illustrates the mixing of air and liquid in the outlet channel of the valve of FIG. 17;

FIG. 21 illustrates the valve of FIG. 20 without a spinner or an extra nozzle;

FIG. 22 illustrates how the liquid and air channels, being so tiny, can be fashioned according to an exemplary embodiment of the present invention;

FIG. 23 illustrates how the droplet size can be controlled by varying the size of the air and liquid channels respectively in exemplary embodiments of the present invention; and

FIG. 24 illustrates the creation of foam by mixing the air and liquid and passing such mix through a fine mesh, according to exemplary embodiments of the present invention.

It is noted that the patent or application file may contain at least one drawing executed in color. If that is the case, copies of this patent or patent application publication with color drawing(s) will be provided by the U.S. Patent and Trademark Office upon request and payment of the necessary fee.

### SUMMARY OF THE INVENTION

A dispensing nozzle is presented that can dispense a controlled liquid stream as a spray or mist or the like with as small as possible droplet size, and as small as possible droplet distribution. The exemplary dispensing nozzle dispenses the controlled liquid stream without dripping or a stream at the beginning or end of the desired dispensing interval. Such dispensing, in exemplary embodiments, is performed with air or other gaseous medium, at the lowest possible pressure.

A spray nozzle device can be provided comprising a housing, a first supply line for supplying a first medium, and a flow channel which guides the first medium to a nozzle of the housing. There can also be provided in the housing a second supply line for supplying a second medium, wherein at least one of the first and second media is substantially liquid. Further provided in the device can be distributing bodies, or elements which cause mixing of the first and second media in various ways, having various possible structures and components. Such distributing bodies operate to feed the second medium into the flow stream as the first media flows through the flow channel, and to thereby cause a mixing of the first medium and second medium. Following such mixing, the mixed media are guided to an outlet nozzle or bore provided in the housing, and ejected out of the housing into the surrounding area. Using injection molding techniques, very fine grooves can be made in an exemplary spray nozzle device, by appropriately fashioning an injection mold. Such grooves can be used as the supply lines and flow channels for air (or other gas) and a liquid. By carefully controlling the size, shape and dimensions of such grooves—given the type, viscosity, molecular composition and self-adhesion of the liquid, and the pressures at which the two media are fed to the spray nozzle device, a correct ratio of air to liquid can be precisely maintained, which is key to obtaining a desired spray or foam as to droplet size, droplet speed, and type of spray, mist or foam.

### DETAILED DESCRIPTION OF THE INVENTION

In exemplary embodiments of the present invention a spray nozzle device can be provided comprising a housing, a first supply line for supplying a first medium, and a flow channel for the first supply line guiding the first medium to a nozzle of the housing. There can also be provided in the housing a second supply line for supplying a second medium, wherein at least one of the first and second media is substantially liquid. Further provided in the device can be dispersing bodies, or devices which cause mixing of the first and second media in various ways, having various possible structures and components. Such dispersing bodies operate as the first media flows through the flow channel to feed the second medium into the flow steam, and to thereby cause a mixture of the first medium and second medium. Following such mixing, the mixed media are guided to an outlet nozzle or bore provided in the housing, from whence the mixture of first and second media are ejected out of the housing and into the surrounding area. In exemplary embodiments of the present invention, the two media are mixed at essentially the end of their pathway through the device. Mixed liquid is compressible, so it is more effective to cause the mixing at the end. Additionally, by mixing the liquid significantly, and also dispensing an air stream prior to and after the stream of mixed liquid is dispensed, as described in detail below, less pressure needs to be used. This is in contrast to, for example, a conventional aerosol can, which requires significant pressure, and thus energy, in order to spray the aerosol at the right speed through the canals and nozzle. Thus, in exemplary embodiments of the present invention significantly lower pressures can be used, at a significant energy savings.

Thus, due to the structure, position, shape and components of the dispersing bodies, as the first medium is moved through the flow channel in the direction of the nozzle of the device, and during such movement comes into contact with the second medium that is also fed to the device, a mixture of the first medium and second medium are created, where the droplets can have various droplet sizes, speeds, and type of spray or mist, given the type, viscosity, adhesion of the liquid to itself (“stickiness”), and other properties of the liquid and the pressures at which the two media are fed to the spray nozzle device.

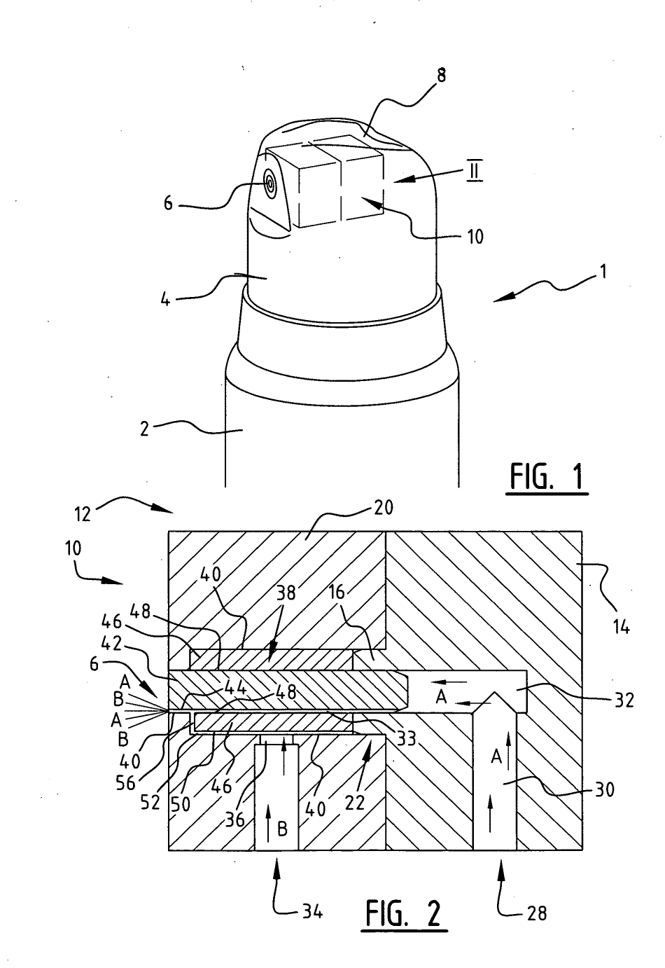

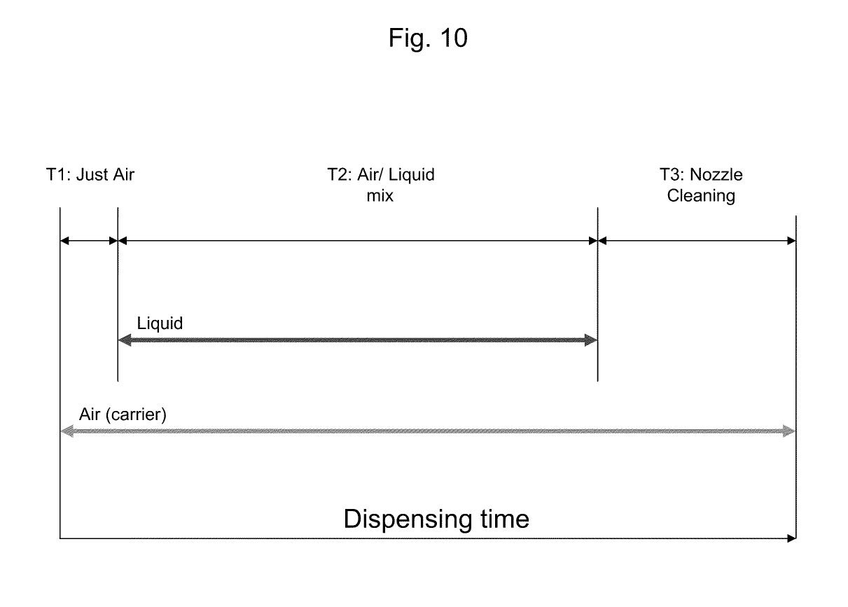

FIGS. 1-9 exemplify various configurations of exemplary spray nozzle devices according to the present invention. FIGS. 10-24 illustrate various systems using exemplary spray nozzles and their operation. First the various exemplary embodiments of spray nozzles in the abstract will be described.

According to one exemplary embodiment, as shown in FIG. 2, the dispersants can carry the fluid in the flow channel so that a mixture of the first medium and the second medium occurs.

Because the liquid medium is fed to the flow channel, the flow channel forms a mixture of the first and the second media. Given the limited dimensions of the flow channel, and thus the resistance it provides to fluid flow, the first and second media thus proceed along the flow channel with limited movement, thus ensuring that proper mixing occurs.

According to one exemplary embodiment, the flow channel can have a cross-sectional area as small as, for example, in the range of 0.03-0.3 mm². By using a flow channel with such a small cross-sectional area, which is not directly realizable with simple injection molding techniques, and which, according to the present invention can only be realized in an economically feasible manner using certain injection-based manufacturing processes, an improved mixing of the first and second media is accomplished.

In exemplary embodiments of the present invention, in which mixing of a basically gaseous medium and a substantially liquid medium occurs, the liquid droplets breakup into smaller droplet sizes and are eventually distributed as a fine mist. Droplets in general will break up as a result of pressure, speed, tumbling and mixing with gas. Which of these factors is operative and to what relative extent is generally specific to a given liquid type.

In exemplary embodiments of the present invention, the dispersants can comprise one or more channels. The dispersants carry the liquid medium to the flow channel via the flowing gaseous medium. By using multiple channels, it is possible to flow the liquid medium that is fed to the flow channel proportionally to the number of channels to increase until a desired flow is reached that leads to a desired mix.

In exemplary embodiments of the present invention, the dispersants can comprise a substantially porous material, as shown in FIGS. 4-8, for example. A substantially porous material has essentially an infinite number of channels, which together both (i) reduce the droplet size of the liquid medium when it is moved through the porous material and (ii) spread the second medium over a larger area to enter the flow channel through which the first medium is flowing. This small drop size, combined with the increased contact area due to the large number of channels formed by the pores of the porous material, brings about an improved mixing of the first and second media.

In exemplary embodiments of the present invention, the porous medium can be made of a sponge-like material. Such a spongy material can absorbs the liquid medium and then “sweat” it out in small drops in the flow channel, where it comes into contact with the first medium and will thus mix.

In exemplary embodiments of the present invention, the porous medium can be, for example, a sintered plastic material, and can thus have, for example, pores with a diameter in the range of, for example, 10 to 300 pm. Such sintered plastic can be, for example, sintered polyethylene. Alternatively, ceramic or woven materials, such as, for example, Gore-Tex™, can be used, as well as any other material which has or creates numerous small canals inside it.

According to a still further preferred embodiment, the flow channel and/or the nozzle can be formed by a recess between the outer wall of a nozzle insert and the inside wall of an interior space in the housing, as shown, for example, in FIGS. 2-4. Although it is conceivable that the nozzle—for example through a hole—is formed in the housing, in exemplary embodiments of the present invention, the nozzle can be formed by a recess between the outer wall of a nozzle insert and an inner wall of an interior space in the housing. Such a recess can be comprised of a groove provided in either part, or, for example, a smaller groove provided in both parts, for example. Canals and grooves according to exemplary embodiments of the present invention can be made either in an outer part or an inner part, or in both.

In exemplary embodiments of the present invention such a recess between the outer wall of such a nozzle insert and the inner wall of the interior space can be made by creating a groove in an outer wall of a nozzle insert. Fixing the groove in a wall of the nozzle insert has the advantage that the exterior of such a nozzle insert is easily accessible for machining, or if injection molding is used. In exemplary embodiments of the present invention such a nozzle insert with pre-formed groove(s) cab be injection molded.

According to a still further preferred embodiment, the recess between the outer wall of a nozzle insert and the inner wall of an interior space in the housing can be made by recessing the lining (inner wall) of the interior of the housing. In exemplary embodiments of the present invention this can be done via injection molding of the spray nozzle housing. It is noted that while FIGS. 1-9 depict exemplary nozzle housings as composed of two or three parts, if injection molding is used the nozzle housing can be made as one part using injection molding.

In exemplary embodiments of the present invention, more than one nozzle can be provided. If flow channels with such a small cross section as described above are provided, it is conceivable that—to obtain a sufficient flow—multiple flow channels can be provided in the dispersants. By using 2, 3, 4, and even 5 or more nozzles, sufficiently high flow rates combined with a spray mist with very small droplet size can be achieved.

In exemplary embodiments of the present invention an exemplary device can include a supply line insert connecting one or more pipes between the second supply line and the flow channel.

The present invention also relates to a method for producing a flow channel, comprising providing a housing to make a first substantially rectangular recess with an inner wall, in the recess applying an insert with an outer wall formed so as to tightly fit with at least a portion of the length of the inner wall of the recess, and wherein either the inner wall of the recess and/or the outer wall of the insert, or both, at least one substantially elongated groove is provided. By using this method it is possible to provide one or more flow channels that have a smaller cross-sectional area than is possible with conventional techniques such as drilling such a flow channel. As with current direct injection molding techniques a flow channel with a minimum cross section of 0.125 mm² feasible, using the methods of the present invention, by means of an exemplary indirect injection molding process flow channels with a much smaller cross-sectional area are feasible.

It is noted at this juncture that the precise dimensions of such flow channels and related canals are formed in the injection molds themselves. If one would attempt to make a canal using a pin (in the injection molding sense of the term—a long metallic cylinder used to create a groove in an area of the plastic—then one would easily see flashes/burrs, and damaged and broken pins. Moreover, the degree of success of this technique is highly mold and process dependent. Thus, using pins is rather risky, and limited in possible sizes. However, by creating the grooves and canals in the molds themselves, by, for example, creating a precisely dimensioned cylindrical projection on an outside portion or in the core, repeated consistent grooves in the molded part can be achieved.

In exemplary embodiments of the present invention a valve insert can be positioned so that its outer wall is substantially close fitting on the inner wall of the recess, at least along a portion of the length of the inner wall of the recess, and a groove or grooves can be provided between said valve insert and said inner wall of said recess.

In exemplary embodiments of the present invention the housing can comprise two parts, and there can be an interior space between the two parts which can be filled with one or more inserts containing dispersants or components to achieve the mixing. Because such dispersants are provided in the interior of the housing, they are securely fastened therein, and thus ensure that the second medium can only flow through the dispersants to the flow channel and out the nozzle.

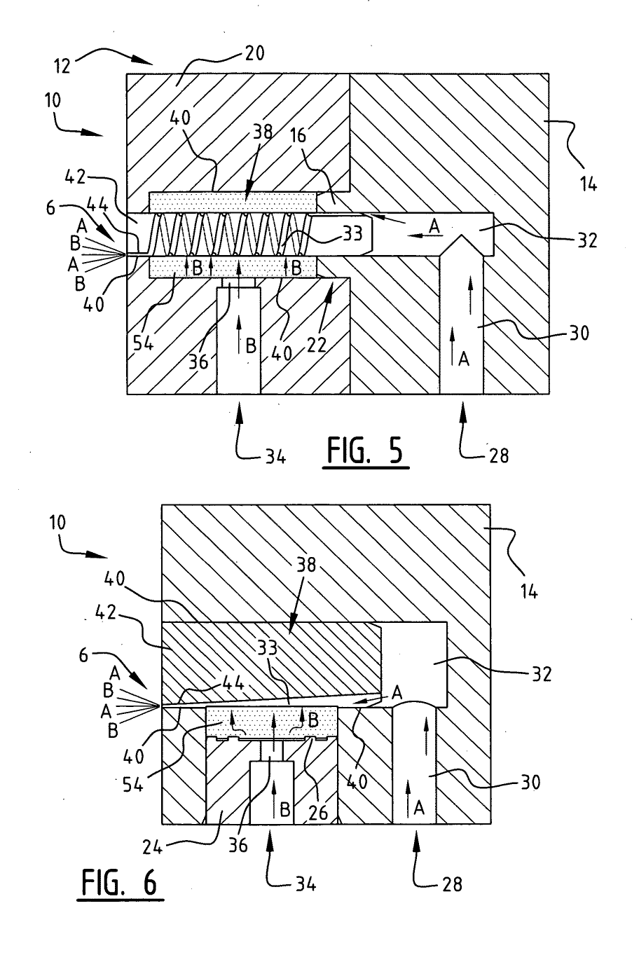

In exemplary embodiments of the present invention the at least one groove can be substantially straight (FIGS. 2-4), tapered (FIG. 6) or substantially helical or spiral (FIG. 5), or for example, of any other type or 3D shape that can create a small liquid stream and can serve to break-up a liquid into tiny droplets. A helical groove, for example, has the advantage that a relatively long flow channel can be built in a compact space.

In exemplary embodiments of the present invention the at least one groove can have a varying depth. By varying the depth the flow area will also vary, whereby given a constant supply pressure a varying flow of the medium in the flow channel will result. This allows the flow of the medium to vary so as to achieve an optimal mixture between the first and the second medium.

As noted, in exemplary embodiments of the present invention the groove can taper toward the nozzle, allowing the flow of the medium to increase. The reduction of flow area has a displacement effect, whereby the mixing of the first and second media is encouraged.

In the following description of various embodiments of the present invention reference will be made to the drawings.

FIG. 1 depicts an exemplary spray bottle 1 comprising a head portion 4 and a bottle 2 containing, for example, a liquid to be sprayed. Also seen are the positions of two portions of an exemplary housing 10 (two cubic structures one behind the other) and the spray nozzle 6 in head portion 4. A cover can be provided on top of housing 10 (not shown) and the spray nozzle can be operated by means of a button 8 located at the top of head portion 4.

In a first exemplary embodiment, shown in longitudinal cross section in FIG. 2, a mixing device 10 can include a housing 12 formed of a first section 14 and second section 20. In the first section 14 can be provided a first supply line 28 through which a first medium A can be introduced. First supply line 28 can itself be composed of, for example, a first section 30 and a second section 32. Furthermore, first section 14 of housing 12 can have, for example, a first projection 16 that can fit into a recess provided in second part 20, as shown.

Second part 20 of housing 12 can have, for example, a second supply line 34. Second supply line 34 can have a somewhat narrowed end 36 which can be connected to a supply pipe 52. Second part 20 of housing 12 can also have, for example, an interior recess which forms an interior space 38. Interior space 38 can, for example, be provided with an inner wall 40 into which first projection 16 of first part 14 of housing 12 can be properly and securely connected, as shown, in a male-female type coupling. Further, as shown in FIG. 2, a pair of inserts can be positioned in interior space 38, namely nozzle insert 42 and supply pipe insert 46. In alternate exemplary embodiments, supply pipe insert 46 can be replaced with alternative inserts, such as, for example, dispersants of porous material 54, as shown in FIGS. 4-9. In the exemplary embodiment shown in FIG. 2, nozzle insert 42 can be provided with a groove along the lengthwise direction of interior space 38, where it can make contact with at least a portion of the inner wall 40 of said interior space 38.

Where the outer wall 44 of nozzle insert 42 is not in contact with the inner wall 40 of interior space 38, it can be in contact with an inner wall 48 of a supply pipe insert 46 that can be provided around it (recall that the figures are longitudinal cross sections, and the depicted rectangular structures are actually cylindrical inserts or cylindrical rings). In the outer wall 44 of nozzle insert 42 a groove can be formed that creates a flow channel 33 that can have a very small cross-sectional area. Furthermore, it is possible to provide a varying flow area, whose cross-sectional area varies longitudinally, as described below. When nozzle insert 42 is injection molded as an all inclusive pre-recess, the possibilities as to shape, size and location of such a recess are almost unlimited.

Flow channel 33 is thus formed by a grooved portion of outer wall 44 of nozzle insert 42 and a space that is formed between the inner wall 40 of interior space 38 and the inner wall 48 of supply pipe insert 46.

In addition, supply pipe insert 46, which is provided around and essentially concentric with nozzle insert 42 inside chamber 38, can create—after installation—a bent prolonged of second supply pipe 52 so as to form a radially extending (vertically in the figure) channel 56. This can be a vertical or radial groove in the end of supply pipe insert 46, for example.

When a liquid B is supplied by second supply pipe 34 through narrowed end 36, and flows through extended second supply pipe 52 via channel 56, it comes in contact with a gaseous medium A, such as, for example, air, which is supplied under pressure via first supply line 30. In exemplary embodiments of the present invention, flow channel 33 and channel 56 can be made so as to have very low flow area, so that the coming together of the two streaming media A and B results in a fine mixture, which then can be sprayed through nozzle 6 as a particulate mist into the environment, as shown (A and B mixed in outflow spray).

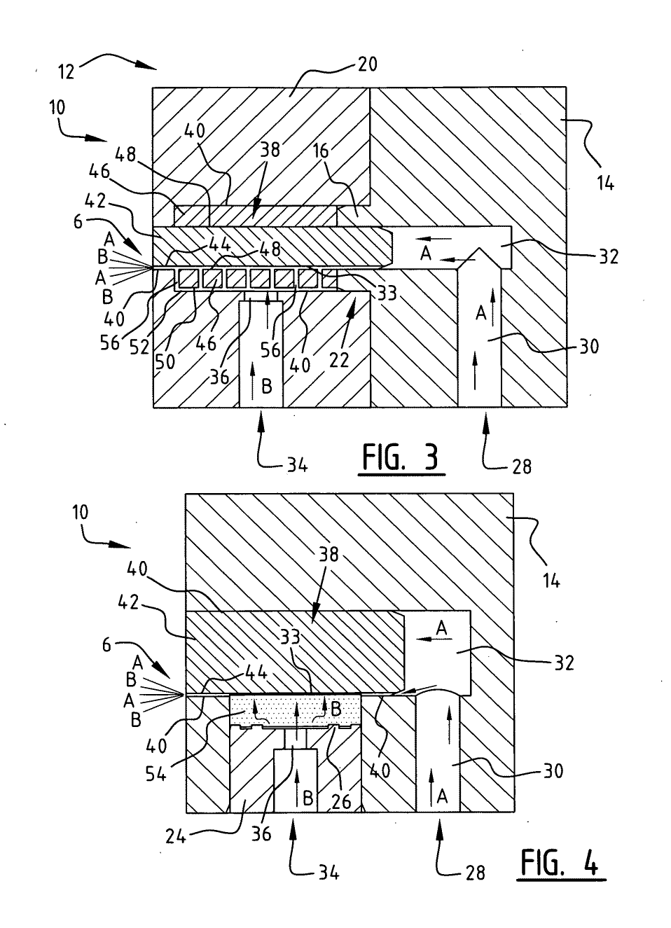

It is noted that the construction of housing 12 for some of the other embodiments, which are further described below, in particular those depicted in FIGS. 3, 5 and 7, is identical to that shown in FIG. 2, and will thus not be repeated. With respect to these other embodiments, only the differences from the exemplary embodiment shown in FIG. 2 will be detailed.

In FIG. 3 a second exemplary embodiment of device 10 is shown. Here, supply pipe insert 46 can be provided with multiple (vertical) channels 56, which allow for a meeting of the gaseous medium A and the liquid medium B at several points in flow channel 33. In the embodiment shown in FIG. 3, for example, there are seven locations where the first medium A and the second medium B meet, leading to significantly improved mixing between the first and second media A and B. The remainder of the exemplary embodiment shown in FIG. 3 is the same as the preferred embodiment shown in FIG. 2, and described above.

FIG. 4 depicts a third exemplary embodiment of the present invention. Here, in inner space 38 nozzle insert 42 is provided, and in the outer wall 44 of such nozzle insert 42 a groove-shaped recess is provided. Thus, a flow channel 33 is interposed between the lower outer wall 44 of nozzle insert 42 and the inner wall 40 of inner space 38. In line with the second supply pipe 34 through which fluid B is supplied, is inserted a distributing body 54, which can be made in the form of a porous material. Thus, fluid B is here supplied through a labyrinth of pores in said distributing body 54, which can be understood as a set of multiple channels, and out through flow channel 33. The pressure of gas A at flow channel 33 directed towards nozzle 6 is thus brought into contact with liquid B through the pores of the porous material of distributing body 54, allowing an admixture.

When a porous material with a labyrinth of pores (channels) each having a small cross-sectional area is used, such as, for example, is possible with sintered polyethylene, the droplet size of droplets of liquid B can be significantly reduced as they are supplied to flow channel 33. The contact between these smaller droplets and the gasflow of gas A can lead to a very fine mixture, which can then flow through flow channel 33 to the nozzle 6 and there be distributed to the surrounding environment.

It is noted that housing 12 of the exemplary preferred embodiment shown in FIG. 4 is also constructed of a first part 14 and a second part 24 (each shown with different cross-hatching or diagonal lines). Here, porous distribution body 54 is securely held between the second part 24 of housing 12, nozzle insert 42, and the first part 14 of housing 12 which radially surrounds second part 24. It is also noted that second part 24 of the housing is vertically inserted into a lower portion of first part 14 of the housing, as shown (which, unlike the embodiments of FIGS. 2 and 3, said first part 14 of the housing here extends to underneath nozzle 6) also so that porous distribution body 54 can be so held.

FIG. 5 depicts a fourth exemplary embodiment of the present invention. It has a housing 12 constructed in a similar manner to that of the embodiment shown in FIG. 2. Here however, around nozzle insert 42 are provided dispersants in the form of a porous material 54 (as described in connection with FIG. 4). Additionally, the recess or groove in the outer cylindrical wall 44 of nozzle insert 42 is made in a helical shape so that in a relatively compact length of porous material 54 a relatively long contact path can be provided between flowing gaseous medium A and liquid B as dispersed through porous material 54. Such an increased contact path leads to improved mixing of gaseous medium A with liquid medium B, while the compact size of housing 12 of device 10 can remain unchanged. It is noted in this context that such a helical flow channel 33 could not be realized by conventional drilling techniques, while the manufacture of a groove in an injection molding product, such as in exemplary embodiments of the present invention is easily achievable.

Shown in FIG. 6 is a fifth exemplary embodiment of the present invention. This embodiment is very similar to that of FIG. 4, except that here flow channel 33 has a varying cross-sectional area. This tapered flow channel is also easily formed using injection molding techniques.

In the illustrated embodiment, there is a tapering of flow channel 33 from supply line 32 to nozzle 6. As a result, a crowding effect occurs, leading to an improved mixture of first medium A and second medium B.

Obviously the varying cross-section surface of flow channel 33, and the form thereof, being produced using molding techniques, as is the case in the present invention, is thus not restricted to either a purely tapered recess as shown in FIG. 6, or to a helical path as shown in FIG. 5. It is understood that a groove of varying cross-sectional area, and in various desired shapes, can also be applied in the various embodiments of FIGS. 2-5 as well.

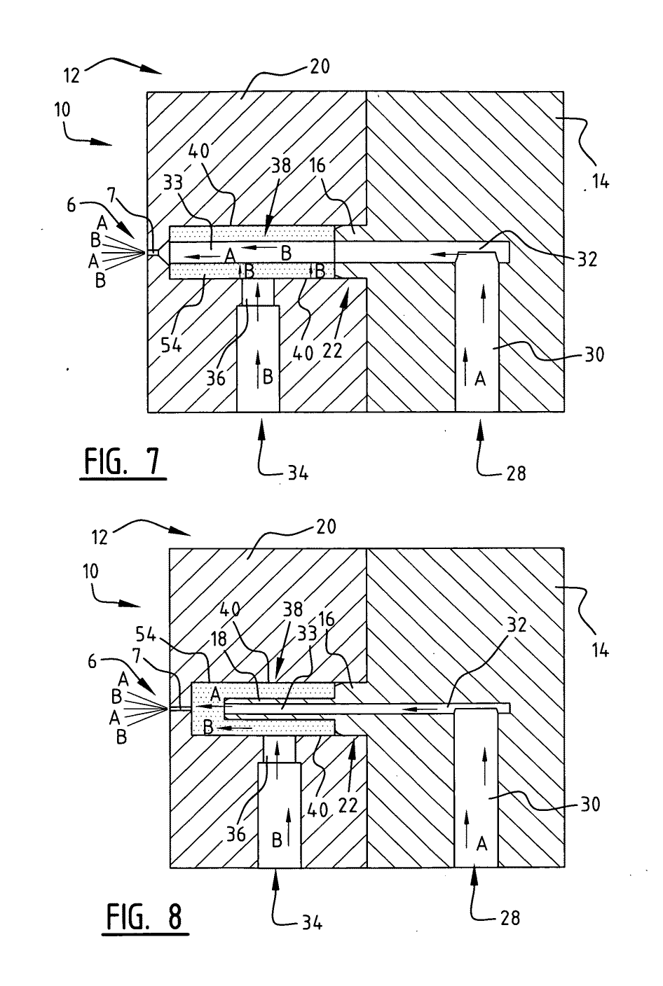

FIG. 7 depicts a sixth exemplary embodiment according to the present invention. Here, as in the embodiments of FIGS. 2 and 3, there are first part 14 and second part 20 of housing 12, and first part 14 is inserted into a recess in second part 20. Distal of the projection 16 from first part 14 is a porous material 54 cylindrical ring provided around a now much larger flow path 32. By moving through the porous material 54, fluid B will go through the pores of porous material 54, its droplet size will be reduced, and it can then come into contact with the flowing gas stream flowing in channel 33, where mixing occurs. This mixture can be further achieved by a tapered shape provided at the end of channel 33 connecting to outflow channel 7 and nozzle 6, which causes a crowding out to occur. This crowding first increases the flow of the mixture of gas A and liquid B, and also enhances the mixing of the two media.

FIG. 8, which shows a seventh exemplary embodiment, is a modification of the embodiment shown in FIG. 7, where the first portion 14 of the housing 12, in addition to first projection 16 also has a second projection 18, through which flow channel 33 (here somewhat narrower) extends. As before, through second supply line 34 liquid medium B diffuses through porous material 54 and comes into contact with the gas flowing through the porous material 54 at the distal end of second projection 18, where a mixing occurs. Here, due to second protrusion 18 which surrounds flow channel 33, the interaction between medium A and liquid B is located more in the here thicker portion of porous material 54 provided at the distal end of second projection 18. The mixture then goes through preformed channel 7 to nozzle 6, and out into the environment.

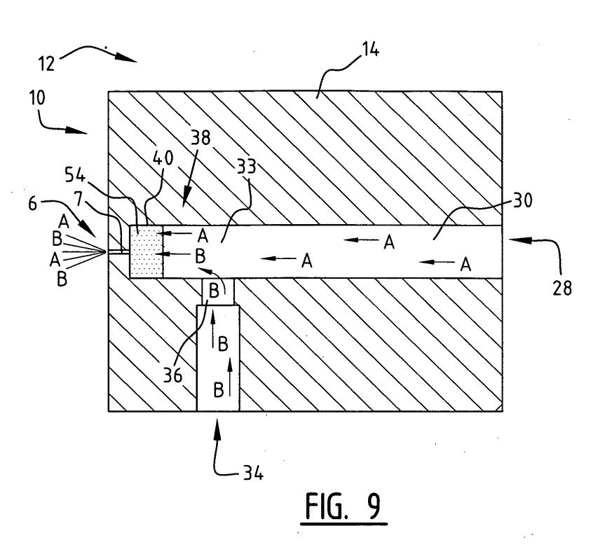

FIG. 9 shows an eighth preferred embodiment, where housing 12 has only a single part 14. Housing 14 is provided with a first supply line 28 for a first medium A, and a second supply line 34 for supplying a second medium B. The media A and B are thus both in flow channel 33 together in inner space 38 prior to being “squeezed” by distributing body 54, which can be a porous body of various types as described above. Because media A and B are pressed through the small channels of distribution body 54, the droplet size of the liquid medium is thus reduced, and a finely divided mixture can be created. The mixture is then guided through a molded channel 7 mounted in housing 14 and then led to nozzle 6, from which the mixture is ejected as a fine mist.

In use, preferably a first flow of gaseous medium A is launched, to which the distributing body 54 provides a flow resistance. Next, the substantially liquid medium B can be introduced, and media A and B compressed together by distribution body 54. Given the microstructure of distribution body 54 a very fine mist-like mixture of gaseous medium A and liquid medium B can occur. After a desired amount of mist-like mixture is dispersed to the surrounding area through nozzle 6, the supply of liquid medium B can be stopped and a short time thereafter the flow of the substantially gaseous medium A can be stopped. Thus, there remains a blow-out of the gas medium A through the system for a short time after spraying and the channels in dispersant 54—where blockages can occur—can be purged.

According to an alternative exemplary embodiment (not shown), it is conceivable that a liquid containing volatile substances can be pressed by distribution body 54, and as the liquid flows through this system a mixture of the liquid and its volatile substances can occur, resulting in a “self induced” fine mist.

Next described are various spray dispensing systems, with reference to FIGS. 10-24.

FIG. 10 illustrates the basic principle of dispensing timing for mixing valves according to exemplary embodiments of the present invention. As shown, first a gaseous medium is sent through the valve by itself, for a time T1; then the liquid is introduced and the mixed spray is dispensed for a time T2. Following that, after the liquid flow ceases, the flow lines are purged or “blown-out” by a blast of the gas only, for a time T3. This process is especially important in exemplary embodiments of the present invention where very small diameter flow lines are used, which can easily becomes clogged. In general, because air is often provided in a compressed form, T1 should be made as short as possible, so as not to waste a supply of compressed air or pump energy. T2 is determined either by a user or any a preset metered dosing quantity set by a metered dosing system. T3 is a function of the potential blockage in the dispensing system, the viscosity and stickiness of the liquid (e.g, hairspray is very sticky, and a dispenser of hairspray would need a longer T3 in general), and other application, system and liquid specific factors.

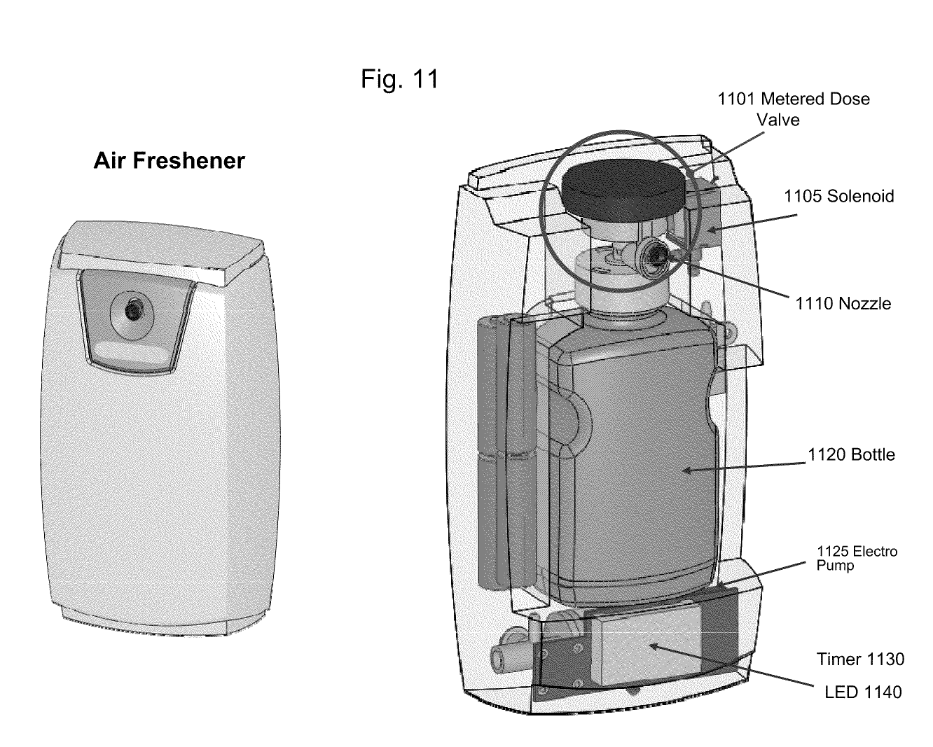

FIG. 11 depicts an exemplary metered dosed valve application according to an exemplary embodiment of the present invention. The focus of the following discussion will be the Metered Dose Valve and its operation. Seen in FIG. 11 are a Metered Dose Valve 1101, a Solenoid 1105 (controls the airflow to operate the valve), a Nozzle 1110, a Bottle 1120, an Electro Pump 1125, a Timer 1130 and an LED 1140. Alternatively, the solenoids (which control pressurized air to actuate the device) can be replaced by, for example, starting an air/gas pump. Such a pump can be manual, electric, gas capsule driven, etc.

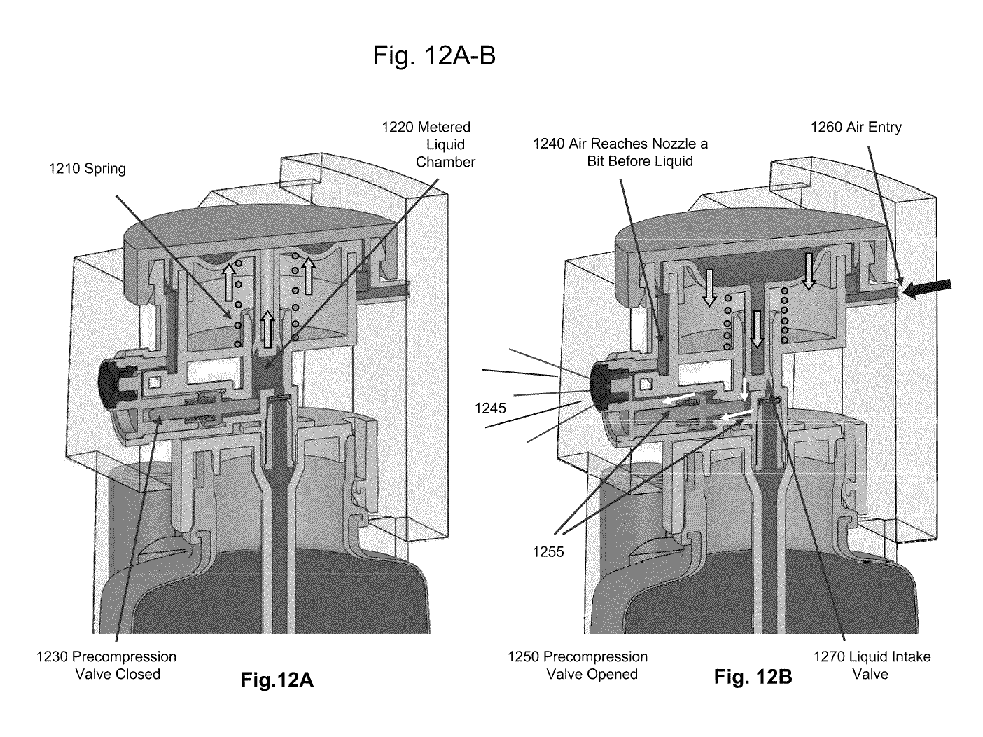

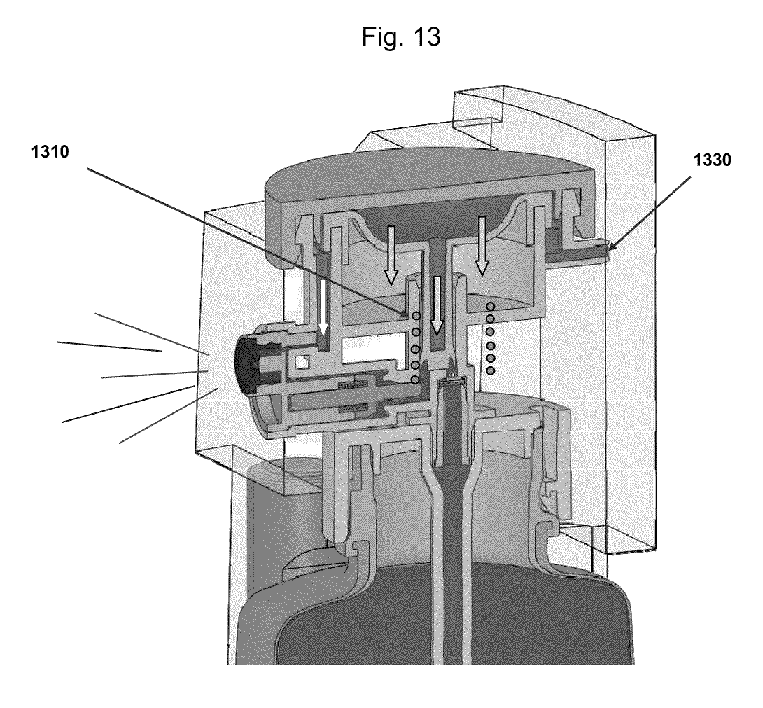

FIGS. 12-13 depict details of the operation of the exemplary metered dosed valve application of FIG. 11. These figures illustrate the principle shown in FIG. 10. In FIG. 12, left image, first the air flow to the valve is closed, and neither air nor liquid flows. The pre-compression valve is closed, and the piston at the top is in its closed position, where the spring is fully extended, and the metered liquid chamber is full of liquid, which can be dispensed. The volume of the metered liquid chamber is precisely what will be dispensed. In FIG. 12, right image, air has entered the valve from the right entry point at the upper left (blue arrow) to activate the dispenser. Thus the piston has been pushed downward against the spring by the force of the air acting over the top surface of the piston, thus pressurizing the liquid in the metered liquid chamber and opening the pre-compression valve. This causes the liquid to be pumped out of the metered liquid chamber and the liquid intake valve to be closed (bottom right of metered liquid chamber). Additionally, the downward movement of the piston allows air to flow over the top of the now depressed piston, and out the nozzle. The air, having less resistance, actually reaches the nozzle first, thus complying with the T1 requirement of FIG. 10. Because the pressure in the liquid chamber opened the pre-compression valve, liquid also flows out of the nozzle, but beginning slightly later than the air flow through the nozzle. Thus a mixture of the air and the liquid flows out of the nozzle, as described above, and as shown in FIG. 12, right image.

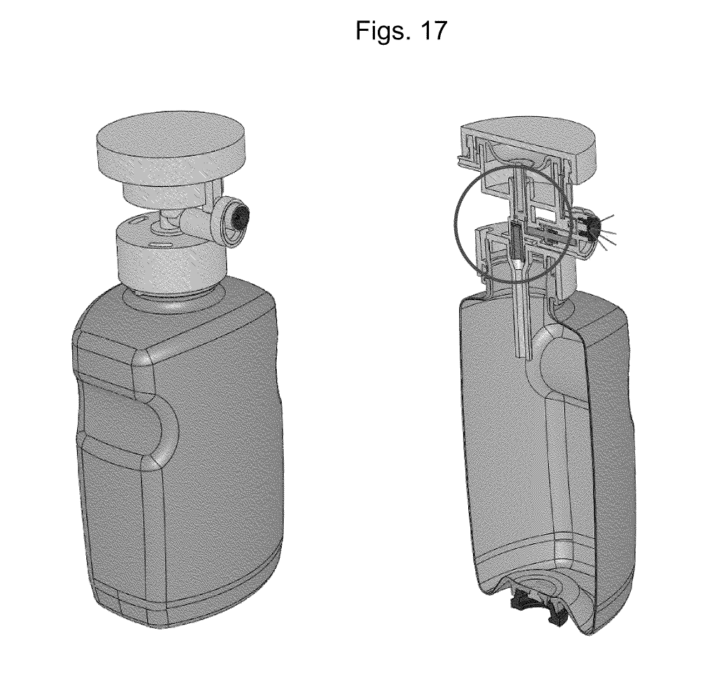

As shown in FIG. 13, the spray continues as long as there remains liquid in the metered chamber. Once this is pumped out, air flow is shut off a little later, but long enough later to allow the continuing air flow to blow out and purge the nozzle, thus satisfying time T3 of FIG. 10. The air flow in this example is driven by a solenoid. Once the air flow is shut off, the spring under the piston will push the piston back to its home position. This will draw liquid through the liquid intake valve and once again fill the metered liquid chamber. It is noted that the liquid can be sucked into the metered liquid chamber in such a post-spraying phase, even in systems where the liquid is not pressurized by a pump or other energy source. As long as the dip tube (shown in FIG. 17) is in contact with the liquid in the bottle, and not air bubbles or air in a headspace, when the piston returns to its home position, the under-pressure in the metered liquid chamber will suck new liquid into the metered liquid chamber, thus refilling it. Although pressurizing the liquid is helpful for this process (such as by applying a pressure by squeezing or using a bag in a bag configuration where the liquid is contained in an inner bag, and there is a pressurized displacement medium between an outer bag and the outer surface of the inner bag), it is in fact not necessary if there is no air gap.

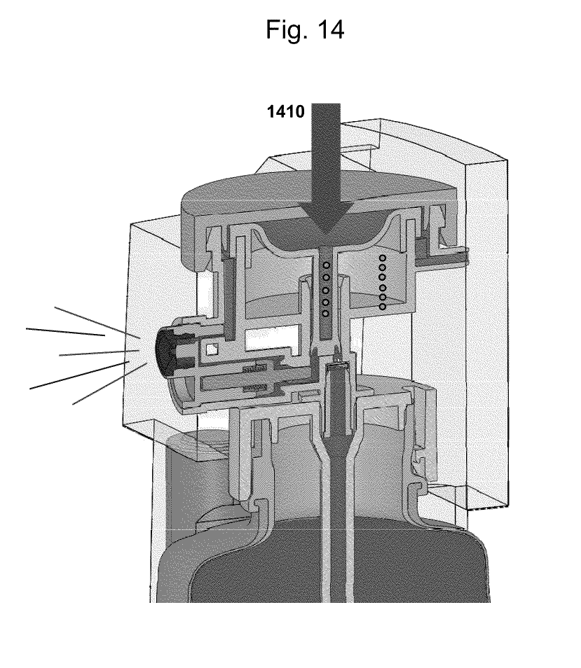

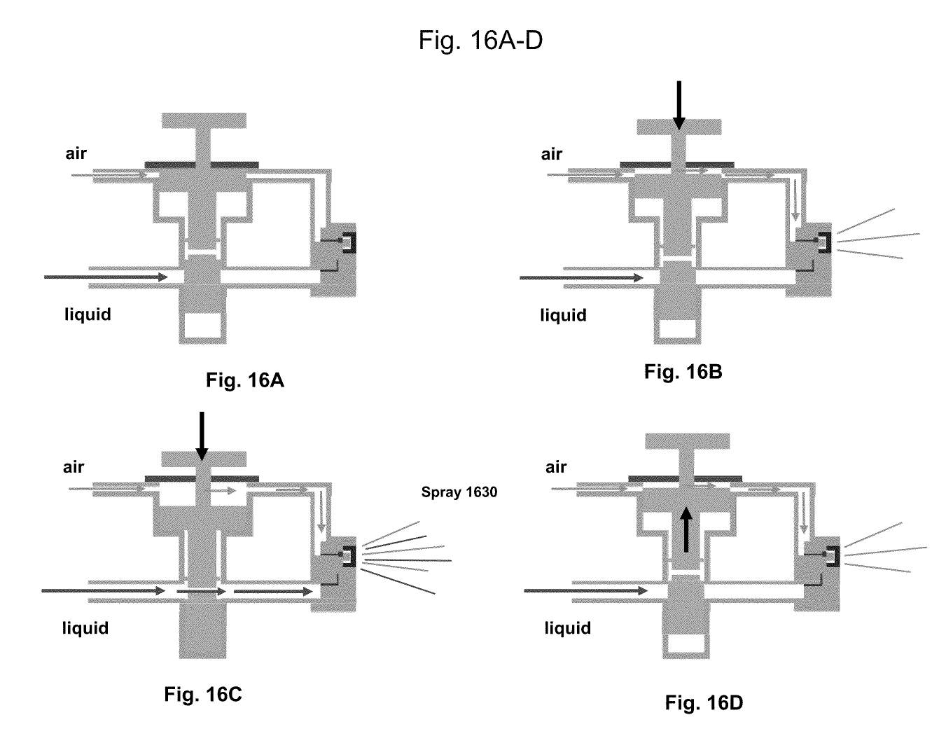

FIG. 14 illustrates how the metered dosed valve of FIGS. 11-13 can be operated manually, where a user's hand actuates the piston instead of an electro-mechanically controlled air flow, such as via, for example, a solenoid. In such manual activation, instead of air being introduced at the air intake and pushing down on the piston, a user pushes on a push button (as shown in FIG. 16), which compresses the air above the piston, and transmits the pressure supplied by the user to push the spring down to its compressed position. This opens air flow to the nozzle, and as described above in connection with FIGS. 12-13, causes the metered liquid chamber to flow past the pre-compression valve and out the nozzle. As described above, as the user lets go of the push button, the liquid is sucked from the bottle into the metered liquid chamber (provided there is liquid contact between the dip tube and the liquid in the bottle), and the air flow to the nozzle eventually shuts off as well, sometime after the mixed liquid/air spray ceases to flow.

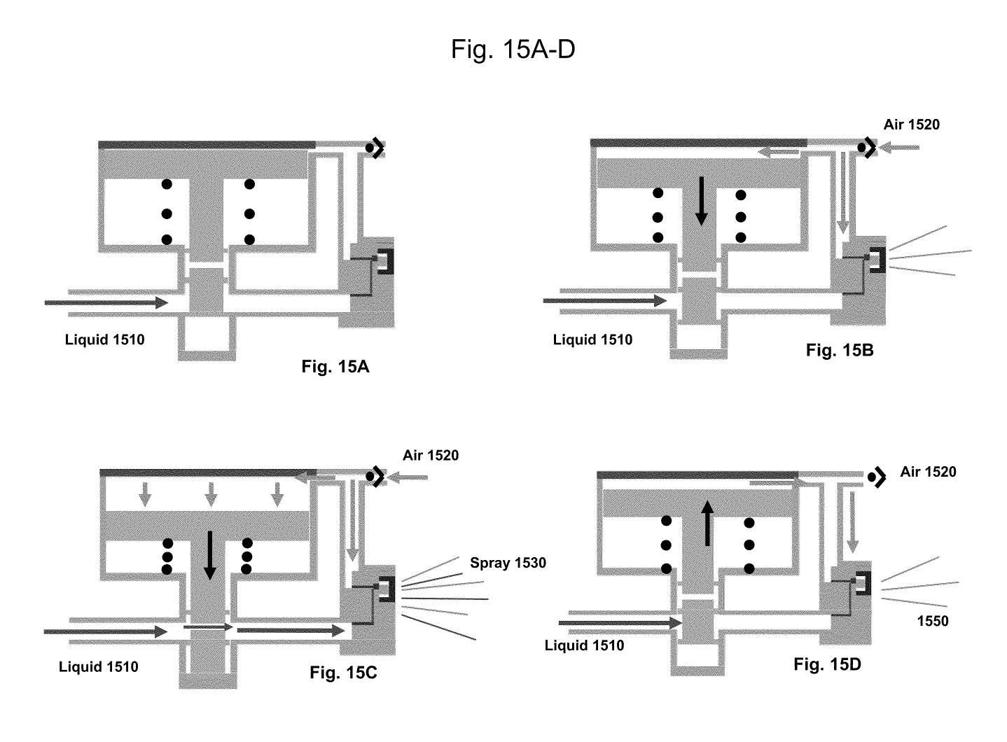

FIG. 15 depict details of the automatic operation of a continuous (non-metered) valve according to an exemplary embodiment of the present invention. The operative principle is the same as described above in connection with FIGS. 12-13, except that here there is no liquid metered dosing chamber. There is a supply of liquid provided to the spray nozzle device, and as long as the valve is open in a dispensing position, liquid will flow. The sequence of figures is to be read by row from left to right, and from top to bottom. Thus, in pane 1 there is neither flow of air nor liquid. In pane 2 air flow begins, for the period T1. In pane 3 both air and liquid flow occur, and liquid enters at the liquid supply line and a mixed spray is output from the nozzle; this illustrates time T2. At 4, which illustrates time T3 liquid flow has ceased, and air flow purges the line. Here air flow is automatically activated, by, for example, a solenoid or other device.

FIG. 16 depicts details of the manual operation of a continuous (non-metered) valve according to an exemplary user activated embodiment of the present invention. The sequence of steps is identical to those of FIG. 15, except that the spray nozzle device is activated by a user pushing down on a push button. As can be seen in FIG. 16, the push button valve is constructed so that immediately upon pushing down the air path opens, as in pane 2, but the liquid path remains closed, as the valve has not been pushed sufficiently downward to align the liquid channel of the valve with the supply line and the flow channel. This situation is thus time T1. Finally, in pane 3, the valve has been pushed down sufficiently to open the liquid flow path between supply line and flow channel, so both liquid and air now flow, and thus a mixed spray outputs from the nozzle. Finally, at pane 4 the user has let up somewhat on the valve, and it returns to a semi-open position, where liquid flow is stopped, but there is a partially open air flow channel across the top of the piston.

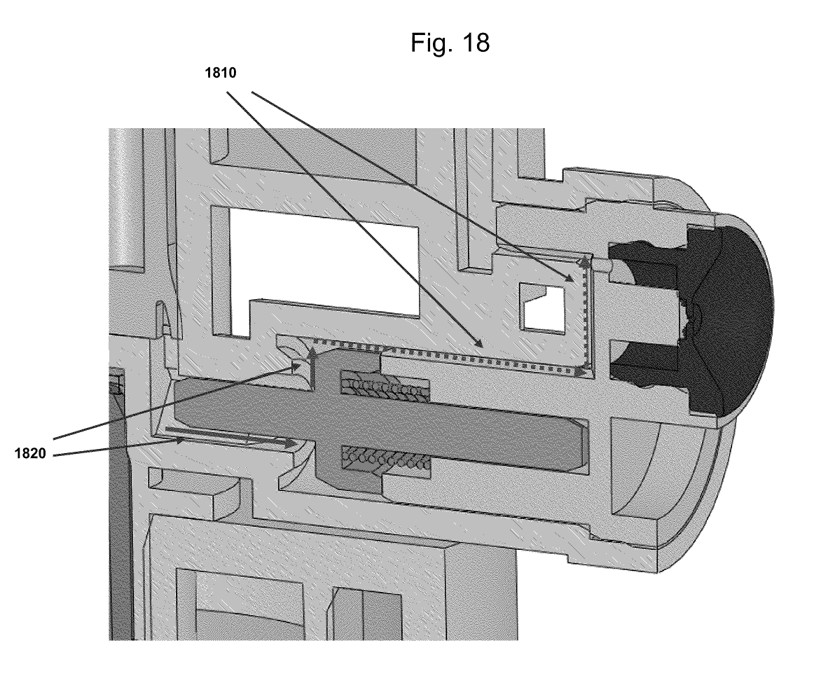

FIG. 17 depicts a perspective view and a cut-away perspective view of an exemplary dispensing device, provided with an exemplary spray valve according to an exemplary embodiment of the present invention. The dip tube described above is shown in this figure. The indicated area of detail in FIG. 17 is next described with reference to FIGS. 18-23.

FIGS. 18-23 depict details of the spray nozzle valve of FIG. 17. Initially the liquid enters the valve via the supply line at a certain speed 1820. This speed is generally not slow enough so as to properly mix the liquid with the air, as shown at 1810. FIG. 18 shows how the liquid speed is carefully slowed down by causing the liquid to travel through a small channel. It is noted how the liquid supply line (the cylindrical ring surrounding the pin) is significantly larger than the small channel used to slow down the liquid.

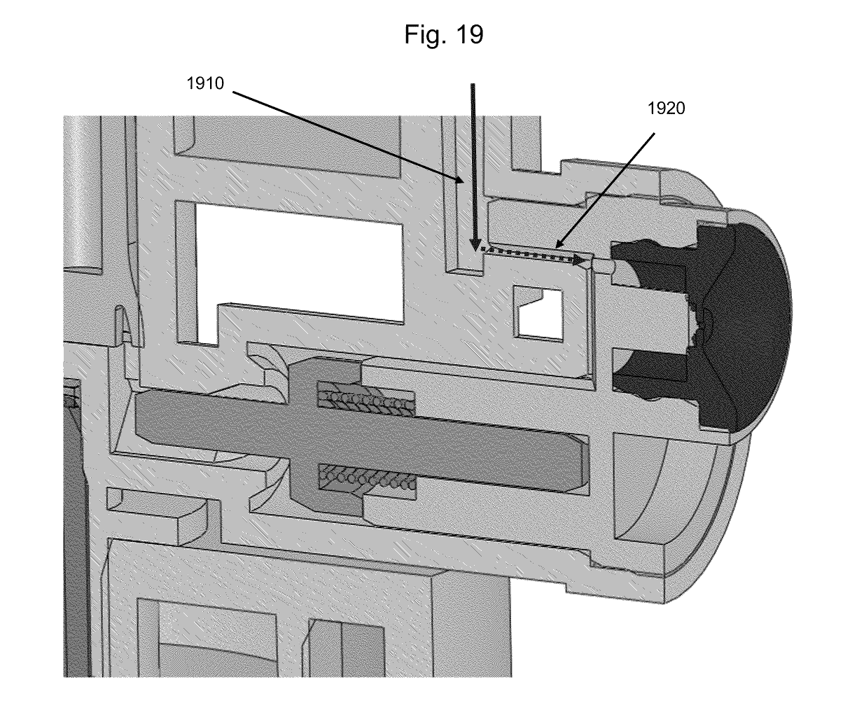

Similarly, FIG. 19 depicts details of the air channel of the valve of FIG. 17. From its supply line the air travels at a certain speed, as shown at 1910. However, it is generally necessary to slow down the air speed to the right level so that the air mixes well with the liquid. If the liquid and the air (or other gas, for example) are moving too fast, then they simply do not interact enough to mix, and effectively “run right by” each other. This slowing down of the air is done by letting the air travel through a very small channel, as shown in FIG. 19, at 1920. The dotted arrow line indicates the small channel through which the air is slowed down. It is noted how the air supply line is significantly larger than the small channel used to slow down the air.

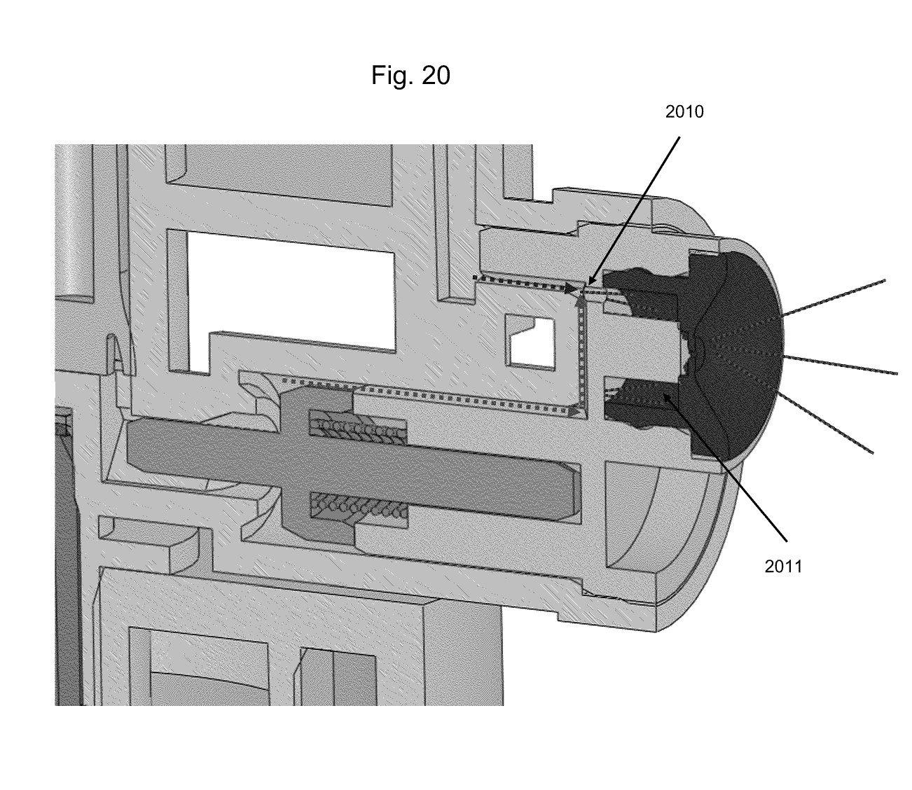

FIG. 20 illustrates the mixing of air and liquid in the outlet channel of the valve of FIG. 17. Because both the air and the liquid were carefully controlled (via slowing their speeds down), as shown at 2010, the air and liquid meet at the right speed and have a good mixing ratio. This mixing ratio is key in regulating spray properties. In general, a liquid/air ratio is always less than 1, and can be, for example, 1/10, ⅕ or even 1/30. The ratio itself is liquid, desired spray properties, and application specific, but given a desired ratio, a system must be designed to precisely and consistently produce it so as to meet the spray quality specifications. This is what the techniques of the present invention allow. Finally, at 2011, the air and liquid mix enter a spin chamber, where they mix even more before leaving the orifice.

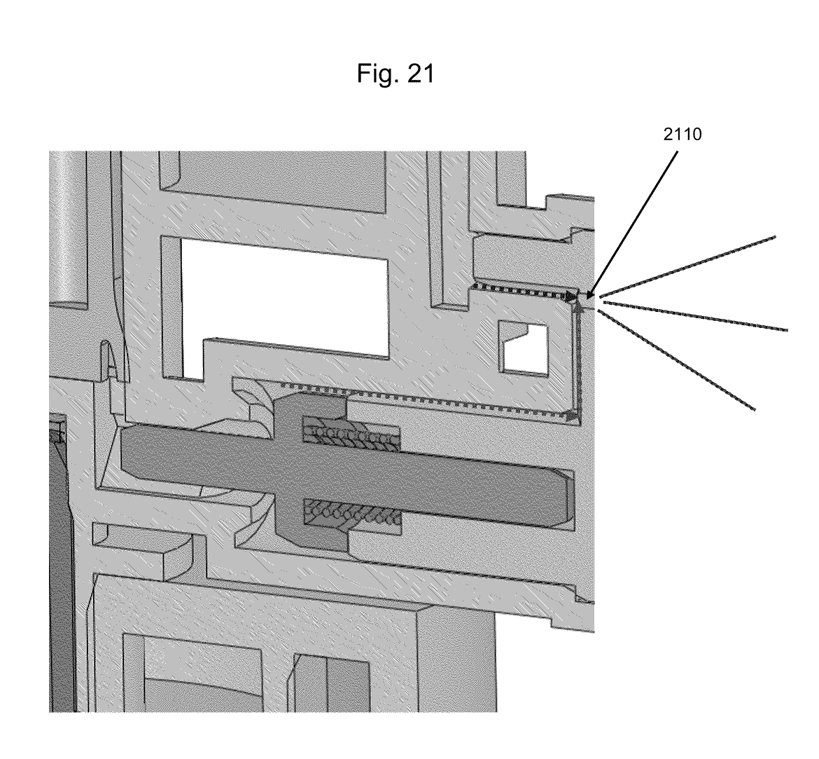

Important in achieving the proper mixing of the liquid and the air, or, for example, other gas, is the length of the canal where the two media come together and are mixed. The length and diameter of such a canal is highly dependent upon the type of liquid. If greater mixing is required, a swirl chamber and nozzle can be used, as shown in FIG. 20. If this is not necessary, the configuration of FIG. 21, for example, can be used.

FIG. 21 illustrates the valve of FIG. 20 without a spinner or an extra nozzle, and thus a part is saved. The spray exits via the nozzle formed at the end of the groove which serves as the flow channel, as described above. The mixing here is only in the outlet bore, where the air and liquid come together. The length of the outlet bore is a function of the liquid and spray angle. The advantage of this exemplary embodiment is that causing a spray to mix in a spin chamber “tires it out” and this decreases its energy, which affects liquid speed of the spray. Here the energy of the moving liquid and air is conserved.

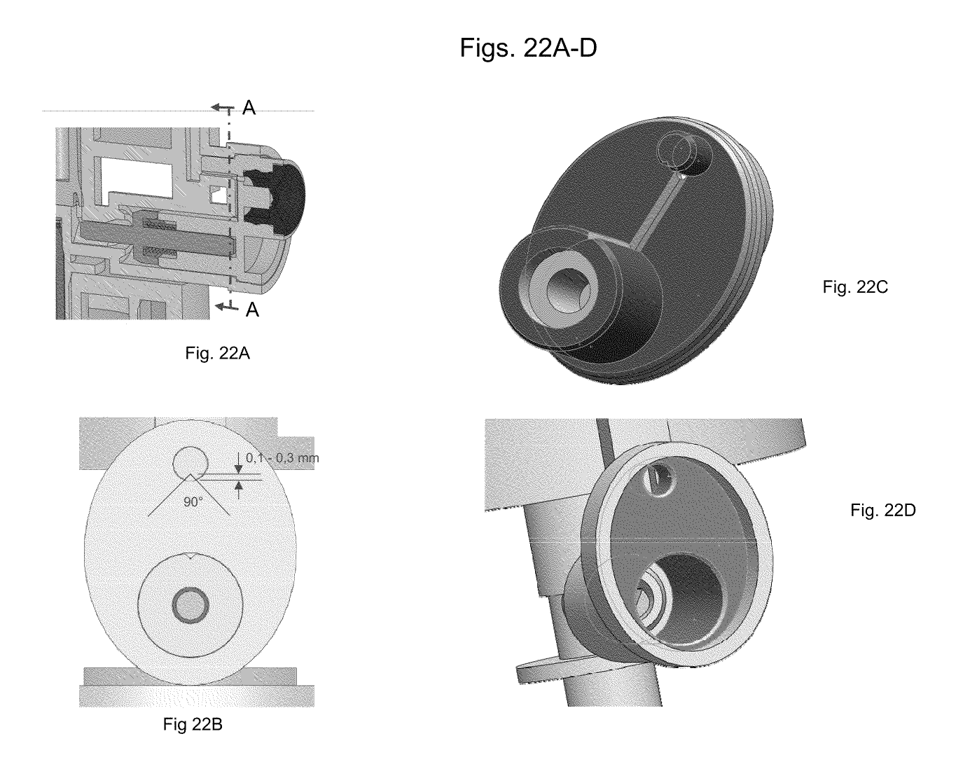

FIG. 22 illustrates how the liquid and air channels, being so tiny, can be carefully fashioned according to an exemplary embodiment of the present invention. Pane B illustrates how small grooves can be created, based on a groove angle and depth. In an injection mold, wherever a groove is desired to be placed in the plastic part, a steel structure, for example, can be added to the mold, so that when the plastic fills the mold and cures, there will be a groove where the steel protrusion was. By very precisely adding such protrusions to a mold, large numbers of precisely grooved plastic parts, such as those shown in pane C, can be created. Combining the grooved part with another which fits flush against it, as in pane D, leaves only the groove as a flow path for the liquid or air. This is how the fine grooves shown in FIGS. 18-20 can be made, and thus, how the liquid and air speed and mixing can be properly and precisely controlled. As noted above, canals and grooves according to exemplary embodiments of the present invention can be made either in an outer part or in an inner part, or even in both.

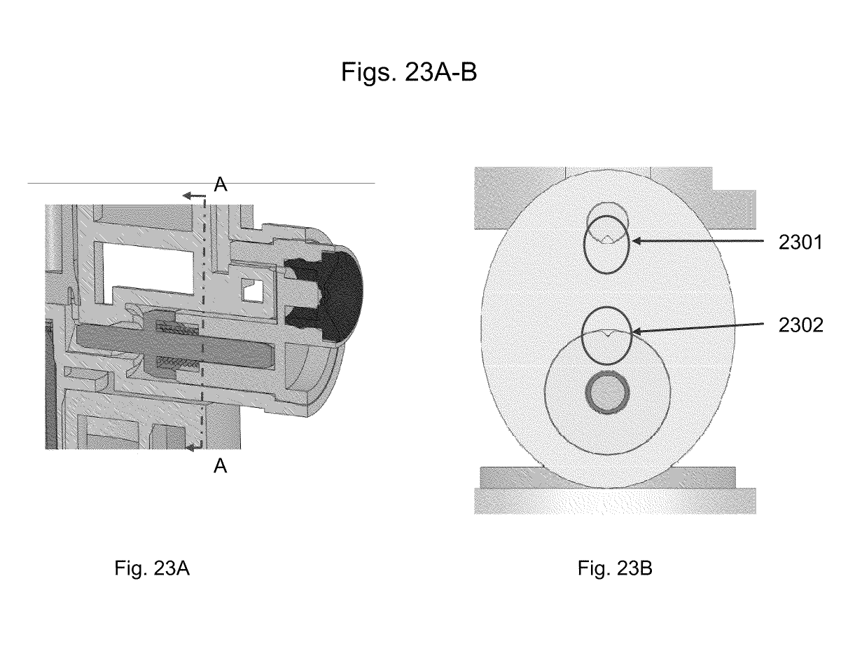

FIG. 23 illustrates how the droplet size can be controlled by varying the size of the air and liquid channels respectively in exemplary embodiments of the present invention. This is seen by looking at an axial cross section of the valve, cutting so as to see the liquid channel and the air channel, which were shown in longitudinal cross section in FIGS. 18 and 19. With reference to FIG. 23, lower image, the droplet size can be varied by changing the air/liquid ratio, which itself can be done by varying the size of the air channel (1) and/or the liquid channel (2). In general, the size of the air and liquid channels, for a given desired air to liquid ratio, is a function of the liquid and the type of spray desired. For finer mists, a higher air to liquid ratio is needed, which causes smaller droplets of liquid.

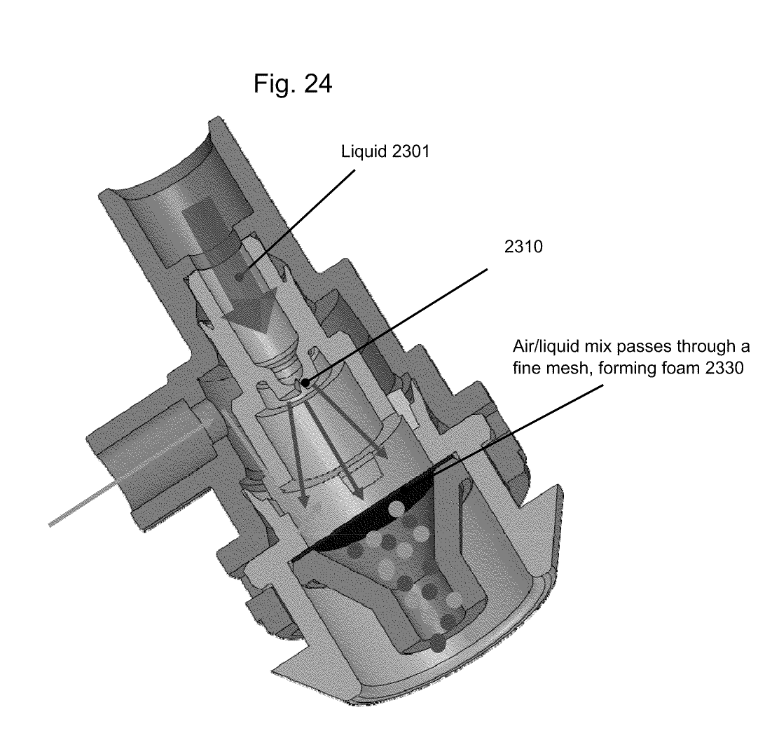

FIG. 24 illustrates the creation of foam by mixing the air and liquid and passing such mix through a fine mesh, according to exemplary embodiments of the present invention.

The above-described embodiments, although preferred embodiments of the invention, only intended to illustrate the present invention and not in any way the definition of limiting the invention. In particular it is noted that one skilled in the art can combine various features of the various embodiments, such as, for example, applying a flow channel with a varying cross-sectional surface. Although the embodiments show the first medium A as gaseous, and the second medium B as substantially liquid, one skilled in the art will realize that this is not necessary, and that the reverse situation could also be implemented. The scope of the invention is thus to be determined solely by the claims that follow.

What is claimed:

1. A media mixing device, comprising:
a housing, comprising:
a first supply line for supplying a first medium;
a flow channel connecting the first supply line to a nozzle;
a second supply line for supplying a second medium, wherein one of the first and second media is substantially liquid;
a distributing body connecting the second supply line to the flow channel so as to mix it with the first medium; and
a nozzle, arranged to output the resulting mixture of said first and second media from the housing to a surrounding area.

2. Device according to claim 1, wherein one or both of the distributing body and the flow channel has a cross-sectional area in the range of 0.03-0.3 mm².

3. Device according to claim 1 or 2, wherein one of the media is mainly gaseous.

4. Device according to claim 1 or 2, wherein the distributing body comprises one or more channels connecting the second supply line to the flow channel.

5. Device according to claim 1 or 2, wherein the distributing body comprises a plurality of micro-channels connecting the second supply line to the flow channel.

5. Device according to claim 1 or 2, wherein the distributing body comprises a substantially porous material.

6. Device according to claim 5, wherein the porous material is spongy.

7. Device according to claim 5, wherein the porous material is a sintered plastic that has pores with a diameter in the range 10 to 300 pm includes.

8. Device according to claim 1 or 2 wherein at least a portion of the flow channel is one of tapered, helical and varying in cross section and/or shape along its length.

9. Device according claim 1, further comprising an interior space provided in the housing, and a nozzle insert provided therein, wherein the flow channel and/or the nozzle is formed by a recess between an outer wall of the nozzle insert and an inner wall of the interior space.

10. Device according to claim 9, wherein the recess comprises a groove in one of the nozzle insert, the inner wall of the interior space and both the nozzle insert and the inner wall of the interior space.

11. Device according to claim 1, further comprising at least one additional nozzle.

12. Device according to claim 1 or 2, wherein at least one of the flow channel and the distributing body are arranged so as to slow down the speed of the medium flowing inside them.

13. Device according to claim 1, further comprising an outlet bore connecting the flow channel to the nozzle.

14. Device according to claim 1 or 2, wherein the cross sectional area and length of each of the flow channel and distributing body are arranged to generate a defined liquid to air ratio.

15. Device according to claim 14, wherein said liquid to air ratio is less than one.

16. Device according to claim 15, wherein said liquid to air ratio is between 1:10 and 1:30.

17. Device according to claim 1 or 2, wherein said housing is made by injection molding.

18. Device according to claim 17, wherein the flow channel and the distributing body are grooves formed between various parts of the housing that fit together.

19. Device according to claim 18, wherein said grooves are formed by forming a protrusion in the mold where the groove is desired to be located.

20. Device according to claim 1 or 2, wherein the cross sectional area and length of each of the flow channel and distributing body are arranged to generate a defined droplet size and a defined distribution of droplet sizes coming out of the nozzle.

21. Device according to claim 1 or 2, wherein the cross sectional area and length of each of the flow channel and distributing body are arranged to generate a defined distribution of droplet speeds coming out of the nozzle.

22. Device according to claim 1 or 2, further comprising a spin chamber to further mix the media prior to outputting the mixture form the nozzle.

23. A method of mixing a gaseous medium with a liquid medium to produce a spray or foam, comprising:
opening a first valve so as to dispense the gaseous medium by itself;
opening a second valve so as to dispense both the gaseous medium and the liquid medium such that they mix;
closing the second valve so as to stop the flow of the liquid medium; and
closing the first valve so as to stop the flow of the gaseous medium.

24. The method of claim 23, wherein the first valve and the second valve are integrated in one part or housing.

25. The method of claim 23, wherein the first valve is automatically actuated by a gaseous medium.

26. The method of claim 23, wherein the first valve is actuated by the same gaseous medium that is being mixed with the liquid medium.

27. The method of claims 23 and 26, wherein both the first and second valves are automatically actuated by a gaseous medium.

28. The method of claim 23, wherein both the first and second valves are activated manually by a user.

29. The method of claim 23, wherein each of the gaseous medium and the liquid medium are conveyed from a supply line through a narrow channel, said narrow channel slowing down the speed of its respective medium prior to its mixing with the other medium.

30. The method of claim 29, wherein the cross sectional area and length of each of the narrow channels are arranged to generate a defined liquid medium to gaseous medium ratio.

31. The method of claim 29, wherein the cross sectional area and length of each of the narrow channels are arranged to generate a defined speed of each medium at the point where they meet and begin to mix.

32. The method of claim 30, wherein said ratio is less than 1.

33. The method of claim 32, wherein said ratio is between 1:5 and 1:50.

34. The method of claim 29, wherein the cross sectional area and length of each of the narrow channels are arranged to generate a defined droplet size of the mixed media in the spray or foam.

35. The method of claim 29, further comprising conveying the liquid medium through a spray nozzle prior to its mixing with the gaseous medium.

36. The method of claim 35, further comprising conveying the mixed media through a mesh so as to generate a foam.
